(19) United States
(12) Patent Application Publication
(10) Pub. No.: US 2010/0211371 A1
(43) Pub. Date: Aug. 19, 2010

(54) COLLABORATIVE VIRTUAL REALITY SYSTEM AND METHOD FOR MOLECULAR MODELING

(75) Inventors: Jee-In KIM, Seoul (KR); Hyung-Seok KIM, Seoul (KR); Jun LEE, Seoul (KR); Lin-Woo KANG, Seoul (KR)

Correspondence Address: GROSSMAN, TUCKER, PERREAULT & PFLEGER, PLLC, 55 SOUTH COMMERICAL STREET, MANCHESTER, NH, 03101, US

(73) Assignee: KONKUK UNIVERSITY INDUSTRIAL COOPERATION CORP., Seoul (KR)

(21) Appl. No.: 12/535,926

(22) Filed: Aug. 5, 2009

(30) Foreign Application Priority Data
Feb. 13, 2009 (KR) 10-2009-0011792

(51) Int. Cl. G06G 7/48; G06F 3/048

(52) U.S. Cl. 703/11; 715/757

(57) ABSTRACT

A collaborative virtual reality system and a method for molecular modeling are disclosed. In accordance with an embodiment of the present invention, a collaborative server, which is connected to a plurality of experimental terminals through a communication network and which supports a collaborative experiment, that includes a simulation supporting unit, which generates a virtual experimental space for a molecular experiment in accordance with a request from an experimental terminal and which supports a virtual molecular experiment such that the plurality of experimental terminals take part in and perform the molecular experiment through the virtual experimental space, and a session managing unit, which supports communication of data between the plurality of experimental terminals so as to reflect experimental data in accordance with molecular manipulation conducted by the plurality of experimental terminals collaboratively performing the virtual molecular experiment on a same molecule through the virtual experimental space.

### CROSS-REFERENCE TO RELATED APPLICATIONS

This application claims the benefit of Korean Patent Application No. 10-2009-0011792, filed with the Korean Intellectual Property Office on Feb. 13, 2009, the disclosure of which is incorporated herein by reference in its entirety.

### BACKGROUND

1. Technical Field

The present invention relates to a computer simulation for molecular modeling, more specifically to a method and a system of simulating a molecular model by collaborating in a virtual reality.

2. Description of the Related Art

Molecular modeling tools take their origins from Structural Biology, which deals with the study of molecular structures of biological macromolecules in a three-dimensional space to understand the molecular structure and develop new materials and new drugs. Developed first with the X-ray diffraction technology, the molecular modeling tools have become capable of supporting the highly diversified and segmented working environment through NMR, etc., and there are currently a number of computer programs with regard to molecular modeling tools. The molecular modeling tools have been applied in three main categories: visualization of molecular structures, simulation, and web environment. Currently, various kinds of computer programs are in use.

However, the conventional molecular modeling tools are only capable of linking independent or limited systems. The conventional, independent or limited molecular modeling technology may be far from fulfilling the current situation, with the development of the Internet, of requiring scientists in remote locations to often work together through a collaborative system. Therefore, it is needed to develop a new system that can support a collaborative working environment, and a concrete molecular modeling technology according to the system.

### SUMMARY

The present invention provides a collaborative virtual reality system and a method for molecular modeling that allow a plurality of terminals to conduct an experiment on a same molecule.

The present invention also provides a collaborative virtual reality system and a method for molecular modeling that can calculate a test result for molecules through parallel computing using multi-threads.

Moreover, the present invention provides a collaborative virtual reality system and a method for molecular modeling that allow an experiment conducted on a same molecule to be performed without conflict by a plurality of terminals by allowing a sever to manage permission to experiment the same molecule.

In one aspect, the present invention provides a collaborative virtual reality system for molecular experiment and a device of simulating the docking of molecules.

An embodiment of the present invention can provide a collaborative server, which is connected to a plurality of experimental terminals through a communication network and which supports a collaborative experiment, that includes a simulation supporting unit, which generates a virtual experimental space for a molecular experiment in accordance with a request from an experimental terminal and which supports a virtual molecular experiment such that the plurality of experimental terminals take part in and perform the molecular experiment through the virtual experimental space, and a session managing unit, which supports communication of data between the plurality of experimental terminals so as to reflect experimental data in accordance with molecular manipulation conducted by the plurality of experimental terminals collaboratively performing the virtual molecular experiment on a same molecule through the virtual experimental space.

The session managing unit can set and control a permission to experiment on the plurality of experimental terminals collaboratively performing the virtual molecular experiment on a same molecule through the virtual experimental space.

The permission to experiment can be a permission to manipulate the experiment or a permission to monitor the experiment, and an experimental terminal given the permission to manipulate can manipulate the molecule through the virtual molecular experiment. Also, an experimental terminal given the permission to monitor can receive and monitor experimental data of the virtual molecular experiment performed by the experimental terminal given the permission to manipulate.

The experimental data can be position information of the molecule changed by the molecular manipulation.

The simulation supporting unit can generate moving pictures of an experimental process performed by each experimental terminal taking part in the virtual experimental space and performing the virtual molecular experiment, and can store the moving pictures into a predetermined storage area. Here, the storage area is accessible by the experimental terminals taking part in the virtual experimental space.

The simulation supporting unit can measure performance information of each experimental terminal, generate molecular experimental information with image resolution corresponding to the measured performance information, and transmit the molecular experimental information to each experimental terminal.

Another embodiment of the present invention can provide an experimental terminal, which is connected to a collaborative server through a communication network, which performs a docking simulation, and in which the collaborative server supports a collaborative experiment for molecular modeling, that includes a communication unit, which receives molecular experimental information for a molecular experiment from the collaborative server, a rendering unit, which renders three-dimensional molecular information by using the molecular experimental information, an input unit, which is inputted with a command to manipulate the rendered molecular information, and a simulation unit, which performs a docking simulation of molecules through a predetermined energy minimizing calculation by changing the molecular information in accordance with the command to manipulate.

The simulation unit can include a serialization unit, which serializes the changed molecular information, a thread unit, which calculates a charge and a value of Van der Waals forces of molecules in parallel by using the serialized molecular information, and a docking simulation unit, which performs a docking simulation by combining the charge and the value of Van der Waals forces. Here, the thread unit can calculate the charge and the value of Van der Waals forces in parallel by being linked with a graphic processor and a graphic memory.

The thread unit can include a plurality of threads, in which a first thread can calculate a charge by using the serialized molecular information and a second thread can calculate a value of Van der Waals forces by using the serialized molecular information.

The charge is calculated using the equation.

$${E}_{charge} = {\sum }_{i = 1}^{R} {\sum }_{j = 1}^{L} \frac{{q}_{i} {q}_{j}}{4 π ∈ {r}_{ij}}$$

Here, R is the total number of atoms of receptor molecules contained in the molecular information, L is the total number of atoms of ligand molecules contained in the molecular information, i is a natural number representing an ith atom of the receptor molecules, j is a natural number representing a jth atom of the ligand molecules, q is a charge of atoms, and rᵢⱼ is a distance between the ith atom and the jth atom.

The value of Van der Waals forces is calculated using the equation.

$${E}_{VWD} = {\sum }_{i = 1}^{R} {\sum }_{j = 1}^{L} ( \{ {( \frac{{v}_{i} + {v}_{j}}{{r}_{ij}} )}^{12} - {( \frac{{v}_{i} + {v}_{j}}{{r}_{ij}} )}^{6} \} \sqrt{{e}_{i} {e}_{j}} )$$

Here, R is the total number of atoms of receptor molecules contained in the molecular information, L is the total number of atoms of ligand molecules contained in the molecular information, i is a natural number representing an ith atom of the receptor molecules, j is a natural number representing a jth atom of the ligand molecules, v is a Van der Waals radius of atoms, and rᵢⱼ is a distance between the ith atom and the jth atom.

The simulation unit can generate experimental data of the changed molecular information, request the collaborative server to perform a minimum energy calculation, receive a result of the minimum energy calculation of the changed molecular information from the collaborative server, and perform the docking simulation.

The experimental data includes position information of the changed molecular information.

In another aspect, the present invention provides a method for simulating a docking of a plurality of molecules in an experimental terminal, in which the experimental terminal is connected to a collaborative server through a communication network and includes a plurality of graphic processors and memories and in which the collaborative server supports a collaborative experiment on a molecule.

An embodiment of the present invention can provide a method for simulating a docking of a plurality of molecules in an experimental terminal, in which the experimental terminal is connected to a collaborative server through a communication network and includes a plurality of graphic processors and memories and in which the collaborative server supports a collaborative experiment on a molecule, that includes receiving molecular experimental information on a molecule by being connected to the collaborative server, in which the molecule is targeted to be experimented, rendering and outputting three-dimensional molecular information through a predetermined method by using the molecular experimental information, being inputted with a command to manipulate the rendered molecular information, and performing a docking simulation through a predetermined energy minimization calculation by changing the molecular information in accordance with the command to manipulate.

The performing of a docking simulation through a predetermined energy minimizing calculation can include serializing the molecular information, calculating a charge and a value of Van der Waals forces of a molecule through a parallel calculation by using the serialized molecular information, and performing a docking simulation by combining the charge and the value of Van der Waals forces.

The calculating of a charge and a value of Van der Waals forces through a deserializing calculation by using the serialized molecular information can include loading the serialized molecular information to a first graphic memory and calculating the charge by using the serialized molecular information by use of a first graphic processor, in which the serialized molecular information is loaded by a first thread, and loading the serialized molecular information to a second graphic memory and calculating the value of Van der Waals forces by using the serialized molecular information by use of a second graphic processor, in which the serialized molecular information is loaded by a second thread. Here, the first thread and the second thread can be operated in parallel.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a block diagram briefly illustrating the configuration of a collaborative virtual reality system for molecular modeling in accordance with an embodiment of the present invention.

FIG. 2 illustrates LOD renderings by experimental terminals in accordance with an embodiment of the present invention.

FIG. 3 illustrates how a collaborative server gives permission to experiment in accordance with an embodiment of the present invention.

FIG. 4 illustrates a distribution process in accordance with an embodiment of the present invention.

FIG. 5 is a block diagram illustrating the configuration of the inside of a collaborative server in accordance with an embodiment of the present invention.

FIG. 6 is a block diagram illustrating the configuration of the inside of an experimental terminal in accordance with an embodiment of the present invention.

FIG. 7 illustrates graphic images of a molecular model that is rendered and outputted in accordance with an embodiment of the present invention.

FIG. 8 is a block diagram illustrating the function of the inside of a simulation unit in accordance with an embodiment of the present invention.

FIG. 9 illustrates serialized molecular information in accordance with an embodiment of the present invention.

FIG. 10 is a flow diagram illustrating a process of calculating a charge and a value of Van der Waals forces by using multi-threads in accordance with an embodiment of the present invention.

FIG. 11 is an example showing how a plurality of experimental terminals connected to a collaborative server work collaboratively in accordance with an embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The features and advantages of this invention will become apparent through the below drawings and description.

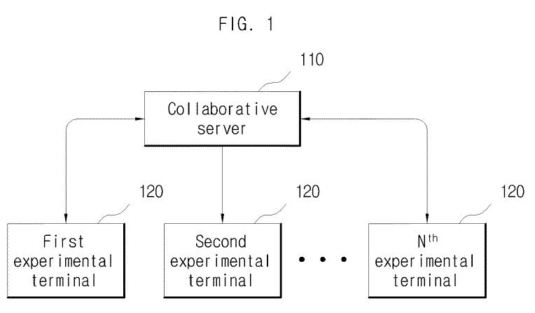

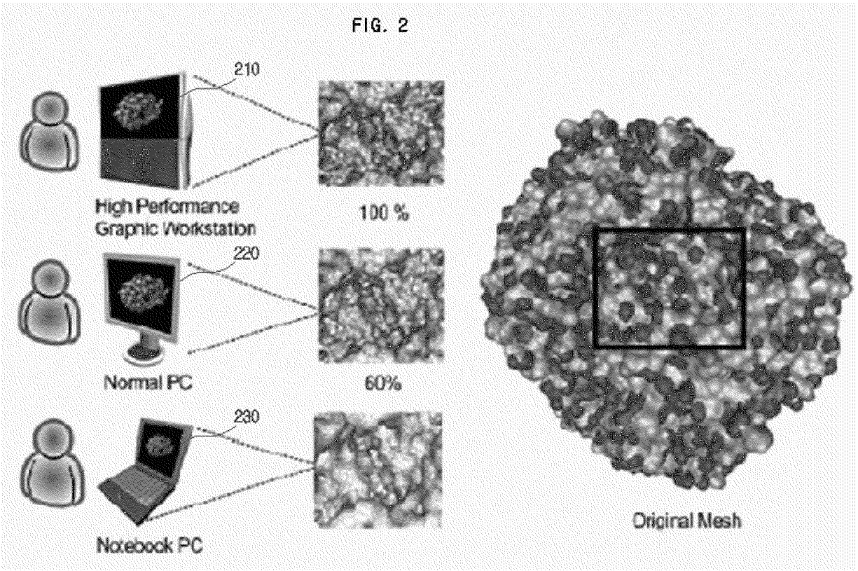

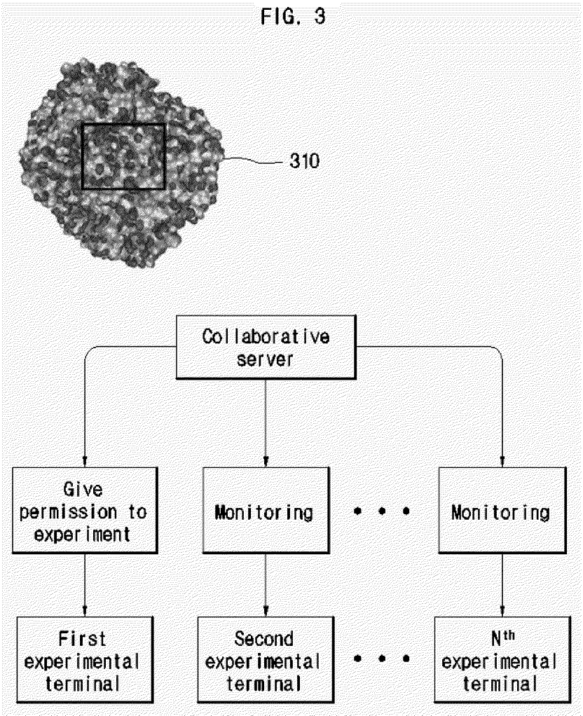

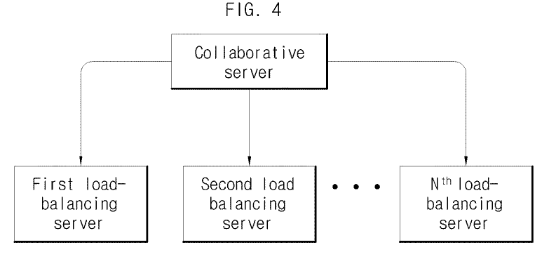

FIG. 1 is a block diagram briefly illustrating the configuration of a collaborative virtual reality system for molecular experiment in accordance with an embodiment of the present invention, and FIG. 2 illustrates LOD renderings by experimental terminals in accordance with an embodiment of the present invention. FIG. 3 illustrates how a collaborative server gives permission to experiment in accordance with an embodiment of the present invention, and FIG. 4 illustrates a distribution process in accordance with an embodiment of the present invention.

As illustrated in FIG. 1, a collaborative system for molecular experiment in accordance with an embodiment of the present invention includes a collaborative server 110 and a plurality of experimental terminals 120.

The collaborative server 110 stores information about one or more molecules (hereinafter, referred to as “molecular information” for the convenience of description and understanding) and supports a virtual experiment on molecules (hereinafter, referred to as “molecular experiment”) performed by a plurality of experimental terminals through a predetermined virtual reality environment.

For example, the collaborative server 110 can create a virtual experimental space in accordance with a request from an experimental terminal and support a plurality of experimental terminals to take part in the virtual experimental space. For this, each of the plurality of experimental terminals can take part in the virtual experimental space by using an avatar that is set in a predetermined virtual reality environment. The collaborative server 110 can generate identification information (hereinafter, referred to as “lab identification information” for the convenience of description and understanding) corresponding to the virtual experimental space such that only an authenticated experimental terminal can be accessed to the virtual experimental space. Also, the collaborative server 110 can transmit the lab identification information to other experimental terminals, which are authenticated by the experimental terminal that created the virtual experimental space. Therefore, an experimental terminal can take part in the virtual experimental space by using the lab identification information.

Also, the collaborative server 110 supports a molecular experiment on molecules performed by each experimental terminal through the virtual experimental space. For this, the collaborative server 110 transmits molecular information corresponding to a request from each experimental terminal.

Furthermore, the collaborative server 110 analyzes the performance of each experimental terminal 120 and transmits molecular experimental information, with different image resolution corresponding to the different performance of each experimental terminal 120, to each experimental terminal 120. That is, the collaborative server 110 measures and analyzes the performance of the processor, memory, graphic card and monitor of each experimental terminal 110 and then transmits molecular experimental information with image resolution based on the performance to each experimental terminal 110. Here, the molecular experimental information can include at least one of the following: name of the molecule for experiment, name information of atoms constituting the molecules, three-dimensional position information, and chemical information for molecular experiment (for example, chemical information of molecular structure, such as temperature, concentration, and the state of aqueous solution).

For better understanding, this will be described in more detail with reference to FIG. 2.

As illustrated in FIG. 2, it shall be assumed that a first experimental terminal is a typical laptop computer, a second experimental terminal is a typical personal computer, and a third experimental terminal is a workstation. For the convenience of describing the present description, it shall be assumed that the image resolution of molecular experimental information being transmitted to the workstation-class experimental terminal is 100% of its original resolution. The collaborative server 110 stores image resolution, which is provided in accordance with the graphic performance of an experimental terminal, in the form of a table (hereinafter, referred to as a “resolution table” for the convenience of description and understanding). For example, it shall be assumed that if an experimental terminal supports ultra-high resolution, molecular experimental information with 100% image resolution is provided; if an experimental terminal supports high-resolution, molecular experimental information with 60% image resolution is provided; and if an experimental terminal supports typical resolution (that is, the remaining resolution excluding the ultra-high resolution and the high resolution), molecular experimental information with 40% image resolution is provided.

The collaborative server 110 generates and provides molecular experimental information with 40% image resolution to the first experimental terminal, because the first experimental terminal is capable of supporting graphics with a typical resolution. The collaborative server 110 generates and provides molecular experimental information with 60% image resolution to the second experimental terminal, because the second experimental terminal is capable of supporting graphics with a high resolution. Moreover, the collaborative server 110 generates and provides molecular experimental information with 100% image resolution to the third experimental terminal, because the third experimental terminal is capable of supporting graphics with an ultra-high resolution.

Furthermore, the collaborative server 110 can support a molecular experiment that is conducted in such a way that a plurality of experimental terminals take part in and work together to perform the molecular experiment in a virtual experimental space. (Hereinafter, this molecular experiment will be referred to as a “collaborative molecular experiment” for the convenience of description and understanding.) However, if the plurality of experimental terminals, which perform the collaborative molecular experiment, manipulate a shared portion of a same molecule at the same time, the molecule may be changed in a direction that is not intended by the experiment. Therefore, in order to minimize the conflict between the plurality of experimental terminals while manipulating the shared portion of the same molecule in the collaborative molecular experiment, the collaborative server 110 can set and give permission to experiment to each experimental terminal. Here, the permission to experiment includes a permission to manipulate and a permission to monitor, and each experimental terminal is given the permission to manipulate or the permission to monitor.

For the convenience of description and understanding, the mechanism of how the collaborative server 110 sets the permission to experiment to the plurality of experimental terminals performing the collaborative molecular experiment will be described with reference to FIG. 3.

Like the reference numeral 310 shown in FIG. 3, it shall be assumed that the collaborative server 110 is requested by a plurality of experimental terminals to perform an experiment on a shared portion of a same molecule. The collaborative server 110 sets and gives the permission to manipulate to a first experimental terminal, which has first requested an experiment, and can give the permission to monitor to a second and third experimental terminals excluding the first experimental terminal. That is, as illustrated in FIG. 3, the collaborative server 110 sets and gives the permission to manipulate to one experimental terminal among the plurality of experimental terminals performing the collaborative molecular experiment, and gives the permission to monitor to the remaining experimental terminals.

Therefore, any conflict caused by performing the collaborative molecular experiment on the shared portion of the same molecule by a plurality of experimental terminals can be minimized.

Referring to FIG. 1 again, the collaborative server 110 can set priorities for a plurality of experimental terminals to determine which experimental terminal will be dealt with first. Thus, when a signal to request an experiment is received from an experimental terminal that has a higher priority than the experimental terminal having the permission to manipulate while the collaborative molecular experiment is performed by a plurality of experimental terminals, the collaborative server 110 can set and give the permission to manipulate to the experimental terminal that has a higher priority.

In an example, it shall be assumed that a first experimental terminal and a second experimental terminal are performing a collaborative molecular experiment. Also, it shall be assumed that the second experimental terminal is set with a relatively higher priority than the first experimental terminal, but the first experimental terminal is set and given the permission to manipulate. At this stage, if the collaborative server 110 receives a signal to request an experiment from the second experimental terminal, the first experimental terminal can be given the permission to monitor, and the second experimental terminal can be given the permission to manipulate, so that the second experimental terminal can manipulate the molecule in the collaborative molecular experiment.

Other detailed functions of the collaborative server 110 will be described in more detail below with reference to the related drawings.

An experimental terminal 120 is connected to the collaborative server 110 through a communication network and provided with molecular experimental information needed for the experiment on molecular modeling from the collaborative server 110. Then, the experimental terminal 120 can perform a docking simulation through a predetermined method using the molecular experimental information.

In the present description, the docking simulation is used to seek an active site, which represents a location where a plurality of molecules are stabilized. In the present invention, the docking simulation is used to evaluate whether the plurality of molecules are coupled to the active site through an energy minimization calculation.

Each of the plurality of experimental terminals 120 changes the position of molecules in accordance with the user's manipulation, and can perform a docking simulation by performing an energy minimization calculation corresponding to the changed position of molecules. Generally, the docking simulation requires a large amount of time in order to calculate the reactions according to the user's molecular manipulation. Accordingly, the experimental terminal 120 is equipped with a plurality of graphic cards, and can perform calculations needed for parallel docking simulations by applying the multi-thread method using each of the plurality of graphic cards. This will be described in more detail below with the related drawings. Also, the mechanism of performing the calculations according to the docking simulation will be described later in more detail when the configuration of the inside of an experimental terminal is described.

In another example, the docking simulation can be performed in parallel by using one or more load-balancing servers through the collaborative server 110.

Referring to FIG. 4, the mechanism of how the calculations needed for the docking simulation are performed in parallel through one or more load-balancing servers in accordance with the command of an experimental terminal 120 will be briefly described hereinafter.

Each load-balancing server downloads and stores the molecular information of each molecular model from the collaborative server 110. Accordingly, an experimental terminal 120 generates experimental information (for example, position information), which is changed in accordance with molecular manipulation, and can transmit the experimental information to the collaborative server 110. Then, the collaborative server 110 monitors the system traffic volume of each load-balancing server, and can transmit the changed experimental information to a load-balancing server in an ascending order of system traffic volume. Therefore, a load-balancing server can perform the calculations needed for the docking simulation, and can transmit the calculation results back to a corresponding experimental terminal 120 through the collaborative server 110.

It is assumed in the present description that the collaborative server 110 monitors a plurality of load-balancing servers and performs scheduling for the calculations of the docking simulation. However, it shall be evident that another server can be prepared for additional work scheduling, depending on the implementing method.

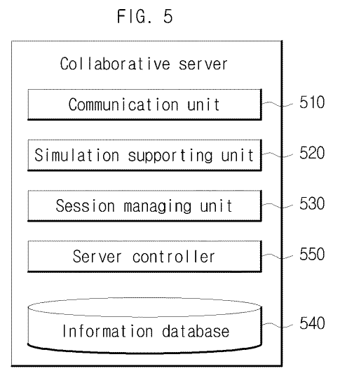

FIG. 5 is a block diagram illustrating the configuration of the inside of a collaborative server in accordance with an embodiment of the present invention.

Referring to FIG. 5, the collaborative server 110 in accordance with an embodiment of the present invention includes a communication unit 510, a simulation supporting unit 520, a session managing unit 530, an information database 540 and a server controller 550.

The communication unit 510 performs the function of receiving and transmitting data between an experimental terminal 120 and a corresponding collaborative server 110 through a communication network.

In an example, the communication unit 510 handles a connection between the experimental terminal 120 and the collaborative server 110 via a communication network. Also, the communication unit 510 sets a session for an experimental terminal 120 connected to the collaborative server 110, generates session information and outputs the session information to the session managing unit 530. Here, the session information can include at least one of the following: identification information of the experimental terminal 120, simulation identification information and time information at which the session is set. Here, a time stamp may be time information at which the experimental terminal 120 requested session allocation. Once the session setting is completed, the communication unit 510 transceives data with each experimental terminal 120 via the established session. The method of setting a session between a plurality of devices in a network is well known to those of ordinary skill in the art, and thus detailed description will be omitted.

The simulation supporting unit 520 generates a virtual experimental space according to a three-dimensional virtual reality environment for molecular experiment, corresponding to a request by the experimental terminal 120. Then, the simulation supporting unit 520 transmits molecular experimental information, which is needed by a plurality of experimental terminals to take part in the virtual experimental space for a molecular experiment on various molecules, to each experimental terminal 120.

Each experimental terminal can take part in the virtual experimental space by using a virtual object, for example, an avatar, (hereinafter, collectively referred to as an “avatar”) provided by the simulation supporting unit 520. Then, each experimental terminal 120, which takes part in the virtual experimental space by using an avatar set for each experimental terminal, can play back moving pictures for various molecular experiments.

That is, the simulation supporting unit 520 stores an experimental process of various molecules as moving pictures. Here, the experimental process is performed by each experimental terminal 120 taking part in the virtual experimental space. The simulation supporting unit 520 also supports other experimental terminals accessing the virtual experimental space to play back the moving pictures stored in the simulation supporting unit 520.

Also, the simulation supporting unit 520 transmits molecular experimental information to each of the plurality of experimental terminals. Here, the molecular experimental information is needed for the plurality of experimental terminals to take part in a same virtual experimental space and to conduct a collaborative molecular experiment on a same molecule. That is, the simulation supporting unit 520 transmits data needed for each experimental terminal to take part in a pre-established virtual reality environment by using a virtual object and to render three-dimensional-mesh-based molecules.

The session managing unit 530 manages connection for transmission of experimental data and transmits the experimental data such that the experimental data from the molecular experiment between the plurality of experimental terminals, which perform the collaborative virtual experiment on the same molecule in the virtual experimental space, can be reflected.

Specifically, the session managing unit 530 manages the session connections of the plurality of experimental terminals performing the collaborative virtual experiment, and if there is any changed experimental data at any experimental terminal, the session managing unit 530 transmits the changed experimental data to the other experimental terminals connected to the session. Accordingly, any new experimental data generated from a molecular experiment between the plurality of experimental terminals can be reflected immediately to the plurality of experimental terminals performing the collaborative virtual experiment. Here, the changed experimental data can be, for example, the changed location information of a molecule.

Also, the session managing unit 530 can receive and transmit chatting data between the plurality of experimental terminals through the session connected between the plurality of experimental terminals performing the collaborative virtual experiment.

Therefore, if any one of the plurality of experimental terminals collaboratively taking part in the collaborative virtual experiment performs a molecular experiment, the other terminals can transmit a message to the experimental terminal performing the experiment by using a chatting service.

Also, the session managing unit 530 performs the function of setting and granting a permission to experiment to the plurality of experimental terminals performing the collaborative virtual experiment. For example, if the plurality of experimental terminals taking part in the collaborative virtual experiment (that is, the plurality of experimental terminals connected to the session corresponding to the collaborative virtual experiment) manipulate a shared portion of a same molecule at the same time, the molecule may be changed in a direction that is different from the intention of each experimental terminal.

To solve this problem, the session managing unit 530 receives a request for ownership right of each object of molecules (hereinafter, referred to as a “target object”) from the plurality of experimental terminals taking part in the collaborative virtual experiment and gives the ownership right of each target object to each experimental terminal.

Here, if two or more experimental terminals request the ownership right of a same object (or a same portion) of molecules, the session managing unit 530 gives the permission to experiment to both of the two or more experimental terminals. Here, as described above, the permission to experiment is either the permission to manipulate or the permission to monitor. The permission to manipulate allows an experimental terminal to perform a molecular experiment by manipulating molecules. The permission to monitor allows an experimental terminal to receive and monitor experimental data generated from the performed molecular experiment. Therefore, an experimental terminal that is given the permission to monitor can not manipulate the target object of the molecules.

The session managing unit 530 can give the permission to manipulate to any one of the plurality of experimental terminals requesting the ownership right of a same object in the collaborative molecular experiment and give the permission to monitor to the remaining experimental terminals.

The information database 540 is stored with molecular information of various molecules, molecular experimental information needed for each molecular experiment, and moving pictures storing the experimental processes performed by each experimental terminal.

The server controller 550 performs the function of controlling the internal components (for example, the communication unit 510, the simulation supporting unit 520, the session managing unit 530 and the information database 540) of the collaborative server 110 in accordance with an embodiment of the present invention.

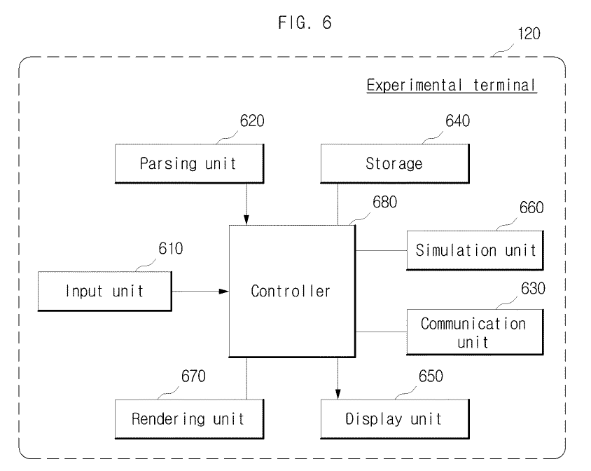

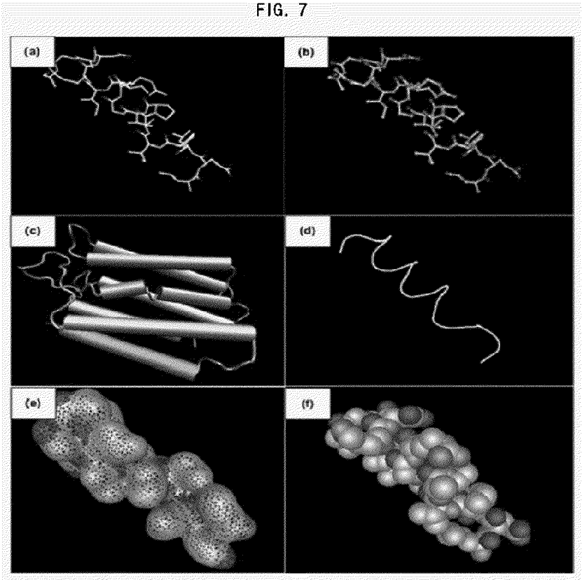

FIG. 6 is a block diagram illustrating the internal configuration of an experimental terminal in accordance with an embodiment of the present invention, and FIG. 7 illustrates graphic images showing virtual computer graphics (renderings) for molecular modeling in accordance with an embodiment of the present invention. Even though it is not illustrated in the present description, the experimental terminal 120 can be equipped with a plurality of graphic cards.

Referring to FIG. 6, an experimental terminal 120 performing a docking simulation of molecules in accordance with an embodiment of the present invention includes an input unit 610, a parsing unit 620, a communication unit 630, a storage 640, a display unit 650, a simulation unit 660, a rendering unit 670 and a controller 680.

The input unit 610 is a means for receiving a control command for controlling the operation of the experimental terminal 120 from the user. Also, the input unit 610 is a means for receiving a control command for manipulating a molecular model in accordance with the user's manipulation. For example, the input unit 610 can be implemented in the form of one of a 3D mouse, a data glove and a haptic interface input device. Of course, it shall be evident that the input unit 610 can be implemented in any form of an input device as long as the input device is capable of outputting a position according to the user's manipulation. That is, the input unit 610 can be also implemented in the form of a plurality of key buttons.

The parsing unit 620 parses three-dimensional molecular structural data after loading it from molecular experimental information, which is downloaded from the collaborative server 110, and generates and outputs experimental target molecular information.

That is, the collaborative server 110 converts molecular information included in the molecular experimental information to the form of XML, VRML, etc. and can transmit the converted molecular information as molecular structure data to an experimental terminal 120.

For example, the molecular structure data includes original data of a three-dimensional protein structure and chemical information of molecules. Depending on the implementing method of molecular structure data, the information on the three-dimensional protein structure and the chemical information can be provided in different files or in a single file.

The communication unit 630 is connected with the collaborative server 110 through a communication network to transceiver the data.

For example, the communication unit 630 can receive molecular experimental information from the collaborative server 110 and output the molecular experimental information to the parsing unit 620. Also, the communication unit 630 can transmit the experimental data that is changed in accordance with the control of the controller 680 to the collaborative server 110.

The storage 640 performs the function of temporally storing molecular experimental information, which is received in units of frames through the communication unit 630. The experimental terminal 120 and the collaborative server 110 transceiver a molecular structure file in units of frames. Therefore, the molecular experimental information received in units of frames by the collaborative server 110 can be temporally stored in the storage 640 and then outputted to the parsing unit 620. The storage 640 can be a temporary storage space such as, for example, a buffer.

Furthermore, the storage 640 stores algorithms, molecular experimental information and changed experimental data, which are needed for operating the experimental terminal 120 in accordance with an embodiment of the present invention.

The display unit 650 outputs molecular experimental information as visual information according to the control of the rending unit 670. The display unit 650 can be implemented in the form of, for example, an LCD screen.

The simulation unit 660 is a means for serializing experimental object molecular information, which is changed in accordance with a manipulation command inputted through the input unit 610, and performing a docking simulation by using the serialized experimental object molecular information through an energy minimization calculation.

In one example, the simulation unit 660 can perform an energy minimization calculation for serialized experimental object molecular information by using multi-threads and perform a docking simulation based on the energy minimization calculation. In another example, the simulation unit 660 can extract position information from the changed experimental object molecular information as the experimental information, transmit the position information to a managing server, and request an energy minimization calculation. For this, the experimental object molecular information can be pre-stored in the managing server. Here, the managing server can change the experimental object molecular information by using the received experimental information, and can control to perform the energy minimization calculation through a plurality of load-balancing servers based on the changed experimental object molecular information. Since this is the same as the previously-described embodiment of the present invention, detailed explanations will be omitted hereinafter, and the mechanism of how the simulation unit 660 performs a docking simulation through an energy minimization calculation using multi-threads will be described hereinafter. The docking simulation performed by the simulation unit 660 through an energy minimization calculation will be described in more detail below with reference to the related drawings.

The rendering unit 670 renders a molecule model three-dimensionally by using the experimental object molecular information. Illustrated in FIG. 7 are molecule models rendered by the rendering unit 670. The molecule model rendered by the rendering unit 670 is outputted by the display unit 650.

The controller 680 controls the internal components (for example, the input unit 610, the parsing unit 620, the communication unit 630, the display unit 650, the simulation unit 660 and the rendering unit 670) of the experimental terminal 120 in accordance with an embodiment of the present invention.

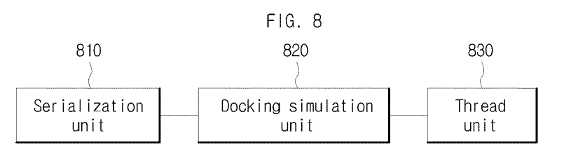

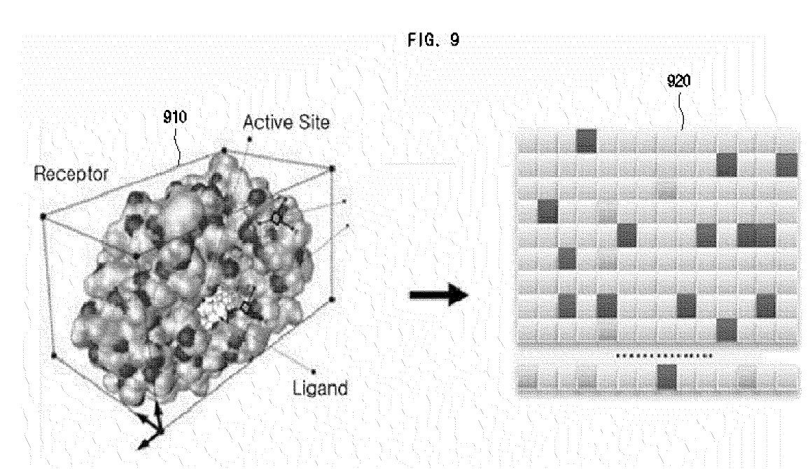

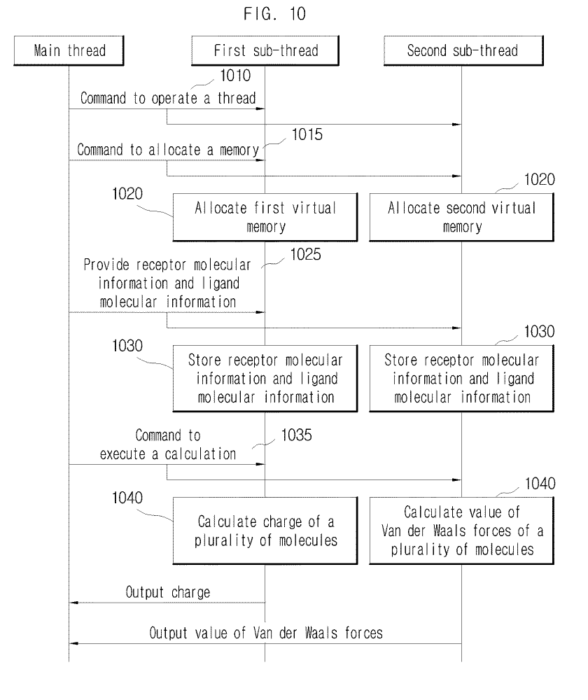

FIG. 8 is a block diagram illustrating the internal function of a simulation unit in accordance with an embodiment of the present invention, and FIG. 9 illustrates serialized molecular information in accordance with an embodiment of the present invention. FIG. 10 is a flow diagram illustrating how a charge and a value of Van der Waals forces are computed using multi-threads in accordance with an embodiment of the present invention.

Referring to FIG. 8, the simulation unit 660 in accordance with an embodiment of the present invention includes a serialization unit 810, a docking simulation unit 820 and a thread unit 830.

The serialization unit 810 serializes the basic information of spatial information of receptor molecules and spatial information of ligand molecules by using the changed experimental object molecular information, and outputs the serialized receptor molecular information and ligand molecular information. 29.

The receptor molecular information has a large molecular weight, and thus the position information of a three-dimensional molecular structure and the chemical symbol information of atoms are divided into several groups with a limited amount each, at which each thread is capable of calculating, and then serialization is performed. However, since the ligand molecular information has a smaller molecular weight, serialization can be performed on the position information of a three-dimensional molecular structure and the chemical symbol information of atoms without splitting.

For the convenience of description and understanding, the information on receptor molecules serialized by the serialization unit 810 will be referred to as “receptor molecular information”. Also, the information on ligand molecules serialized by the serialization unit 810 will be referred to as “ligand molecular information.” In the following description, the receptor molecular information and the ligand molecular information may refer to the spatial information of serialized molecules, so that the receptor molecular information and the ligand molecular information may be interpreted to encompass the meaning of spatial information of serialized molecules.

FIG. 9 illustrates serialized molecular information. Specifically, the serialization unit 810 serializes spatial information of a three-dimensional molecule, like the reference numeral 910 shown in FIG. 9, and outputs the serialized molecular information, like the reference numeral 920 shown in FIG. 9. For example, in the present description, each sub-thread calculates a charge and a value of Van der Waals forces by using a processor and a memory of each graphic card, so that the spatial information of a three-dimensional molecule (that is, the position information and chemical symbols of atoms) can be transformed to a two-dimensional texture and outputted to the memory of each graphic card.

Once the serialized receptor molecular information and ligand molecular information are inputted, the docking simulation unit 820 generates and outputs a command to execute a calculation to the thread unit 830. Then, the docking simulation unit 820 performs a docking simulation of a plurality of molecules by using the charge and the value of Van der Waals forces, which are calculated by the thread unit 830.

As described above, the docking simulation is a simulation for seeking the position of receptor and ligand, at which the plurality of molecules can be coupled to one another more stably. In the present invention, the docking simulation is used to evaluate whether the plurality of molecules are coupled to an active site, which is a stable area for the plurality of molecules, by performing the energy minimization calculation.

The thread unit 830 includes a main thread and a plurality of sub-threads. The thread unit 830 calculates the charge and the value of Van der Waals forces of the plurality of molecules by using the plurality of threads and outputs the charge and the value of Van der Waals forces to the docking simulation unit 820.

Below, for the convenience of description and understanding, the processes of. calculating the charge and the value of Van der Waals forces using the plurality of threads in the thread unit 830 will be described with reference to FIG. 8. It shall be assumed in the following description that an experimental terminal 120 in accordance with an embodiment of the present invention is equipped with a plurality of graphic cards, and each sub-thread linked with each graphic card performs an action and/or an operation. Although it is assumed in the present description that a sub-thread linked with each graphic card performs an action and/or an operation, it shall be evident that if an experimental terminal is equipped with a plurality of cores, the sub-thread linked with each core also can perform the action and/or the operation.

Below, for the convenience of description and understanding, a processor of a first graphic card will be referred to as a “first graphic processor,” and a processor of a second graphic card will be referred to as a “second graphic processor.” Also, a memory of the first graphic card will be referred to as a “first graphic memory,” and a memory of the second graphic card will be referred to as a “second graphic memory.”

In step 1010, the main thread generates a command to operate a thread and outputs the command to each of the plurality of sub-threads.

Then, in step 1015, the main thread generates a command to allocate a memory and outputs the command to each of the plurality of sub-threads.

Accordingly, in step 1020, the plurality of sub-threads each allocate a virtual memory. For example, a first sub-thread can allocate a virtual memory to the first graphic memory (hereinafter, referred to as a “first virtual memory” for the convenience of description and understanding) in accordance with the command to allocate a memory, and a second sub-thread can allocate a virtual memory to the second graphic memory (hereinafter, referred to as a “second virtual memory” for the convenience of description and understanding) in accordance with the command to allocate a memory.

In step 1025, the main thread provides receptor molecular information and ligand molecular information to each of the plurality of sub-threads.

Accordingly, in step 1030, each sub-thread stores the receptor molecular information and the ligand molecular information, which are provided from the main thread, to its own virtual memory.

In step 1035, the main thread generates a command to execute a calculation and transmits the command to each of the plurality of sub-threads.

In step 1040, each sub-thread calculates and outputs a charge and a value of Van der Waals forces in parallel in accordance with the command to execute a calculation, which is transmitted from the main thread.

In one example, the first sub-thread calculates a predetermined charge in accordance with the command to execute a calculation, and the second sub-thread working in parallel with the first sub-thread calculates a predetermined value of Van der Waals forces in accordance with the command to execute a calculation.

First of all, the mechanism of how the first sub-thread calculates the charge of two molecules will be described. The first sub-thread can calculate the charge of the two molecules by using the charge of atoms constituting the two molecules and a distance between the atoms.

For example, the first sub-thread can calculate the charge of the two molecules by using the following mathematical equation 1.

$${E}_{charge} = {\sum }_{i = 1}^{R} {\sum }_{j = 1}^{L} \frac{{q}_{i} {q}_{j}}{4 π ∈ {r}_{ij}} \qquad [ Mathematical Equation 1 ]$$

Here, R is the total number of atoms of receptors; L is the total number of atoms of ligands; i is a natural number representing an ith atom of the receptors; j is a natural number representing a jth atom of the ligands; q is a charge; ε is epsilon; and rᵢⱼ is a distance between the ith atom and the jth atom.

On the other hand, the second sub-thread working in parallel with the first sub-thread but operating independently from the first sub-thread can calculate a value of Van der Waals forces for a plurality of molecules. For example, the second sub-thread can calculate the value of Van der Waals forces for the plurality of molecules by using the Van der Waals forces radius of each atom and a distance between the atoms.

For example, the second sub-thread can calculate the value of Van der Waals forces by using the following mathematical equation 2.

$${E}_{VWD} = {\sum }_{i = 1}^{R} {\sum }_{j = 1}^{L} ( \{ \begin{matrix}{( \frac{{v}_{i} + {v}_{j}}{{r}_{ij}} )}^{12} - \\ {( \frac{{v}_{i} + {v}_{j}}{{r}_{ij}} )}^{6}\end{matrix} \} \sqrt{{e}_{i} {e}_{j}} ) \qquad [ Mathematical Equation 2 ]$$

Here, R is the total number of atoms of receptors; L is the total number of atoms of ligands, i is a natural number representing an ith atom of the receptors; j is a natural number representing a jth atom of the ligands; v is a Van der Waals radius; ε is epsilon; and rᵢⱼ is a distance between the ith atom and the jth atom.

As described above, the thread unit 830 calculates the charge and the value of Van der Waals forces of the plurality of molecules in parallel by using the plurality of threads and outputs the charge and the value of Van der Waals forces to the docking simulation unit 820.

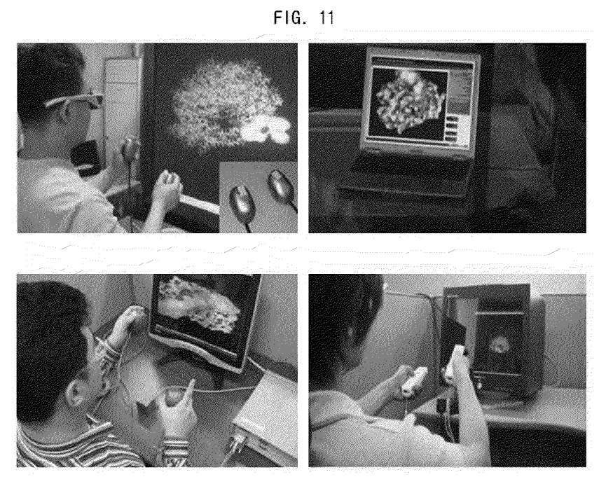

FIG. 11 is an example showing how a plurality of experimental terminals connected to a collaborative server work collaboratively in accordance with an embodiment of the present invention.

As illustrated in FIG. 11, each of the plurality of experimental terminals 120, to which experimental target molecular information with image resolution corresponding to the capacity of the experimental terminal is provided, can render and output molecules to three-dimensional meshes. The experimental terminals 120 are each given the permission to experiment from the collaborative server 110, for non-shared portions in the same experimental target molecular information, and can perform a docking simulation for each of the non-shared portions. Then, each experimental terminal 120 generates outcome information according to each docking simulation, and can transmit the outcome information to a plurality of other experimental terminals, which perform the experiment on the same experimental target molecular information, through the collaborative server 110. The plurality of other experimental terminals receiving the outcome information can render molecules to three-dimensional meshes by reflecting the outcome information to the experimental target molecular information.

However, if the plurality of experimental terminals manipulate shared portions in the same experimental target molecular information at the same time, the experimental terminal that is given the permission to experiment under the control of the collaborative server 110 can only perform the docking simulation by manipulating for the shared portions. In this case, the remaining experimental terminals can monitor the experiment conducted by the experimental terminal that is given the permission to experiment.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

What is claimed is:

1. A collaborative server being connected to a plurality of experimental terminals through a communication network and configured to support a collaborative experiment, the collaborative server comprising:
a simulation supporting unit, configured to generate a virtual experimental space for a molecular experiment in accordance with a request from an experimental terminal and configured to support a virtual molecular experiment such that the plurality of experimental terminals take part in and perform the molecular experiment through the virtual experimental space; and
a session managing unit configured to support communication of data between the plurality of experimental terminals so as to reflect experimental data in accordance with molecular manipulation conducted by the plurality of experimental terminals collaboratively performing the virtual molecular experiment on a same molecule through the virtual experimental space.

2. The collaborative server of claim 1, wherein the session managing unit sets and controls a permission to experiment on the plurality of experimental terminals collaboratively performing the virtual molecular experiment on a same molecule through the virtual experimental space.

3. The collaborative server of claim 2, wherein:
the permission to experiment is a permission to manipulate the experiment or a permission to monitor the experiment;
an experimental terminal given the permission to manipulate can manipulate the molecule through the virtual molecular experiment; and
an experimental terminal given the permission to monitor receives and monitors experimental data of the virtual molecular experiment performed by the experimental terminal given the permission to manipulate.

4. The collaborative server of claim 3, wherein the experimental data is position information of the molecule changed by the molecular manipulation.

5. The collaborative server of claim 1, wherein the simulation supporting unit generates moving pictures of an experimental process performed by each experimental terminal taking part in the virtual experimental space and performing the virtual molecular experiment and stores the moving pictures into a predetermined storage area,
whereas the storage area is accessible by the experimental terminals taking part in the virtual experimental space.

6. The collaborative server of claim 1, wherein the simulation supporting unit measures performance information of each experimental terminal, generates molecular experimental information with image resolution corresponding to the measured performance information, and transmits the molecular experimental information to each experimental terminal.

7. An experimental terminal being connected to a collaborative server through a communication network and configured to perform a docking simulation, the collaborative server supporting a collaborative experiment for molecular modeling, the experimental terminal comprising:
a communication unit configured to receive molecular experimental information for a molecular experiment from the collaborative server;
a rendering unit configured to render three-dimensional molecular information by using the molecular experimental information;
an input unit configured to be inputted with a command to manipulate the rendered molecular information; and
a simulation unit configured to perform a docking simulation of molecules through a predetermined energy minimizing calculation by changing the molecular information in accordance with the command to manipulate.

8. The experimental terminal of claim 7, wherein the simulation unit comprises:
a serialization unit configured to serialize the changed molecular information;
a thread unit configured to calculate a charge and a value of Van der Waals forces of molecules in parallel by using the serialized molecular information; and
a docking simulation unit configured to perform a docking simulation by combining the charge and the value of Van der Waals forces,
whereas the thread unit calculates the charge and the value of Van der Waals forces in parallel by being linked with a graphic processor and a graphic memory.

9. The experimental terminal of claim 8, wherein the thread unit comprises: a plurality of threads;
a first thread configured to calculate a charge by using the serialized molecular information; and
a second thread configured to calculate a value of Van der Waals forces by using the serialized molecular information.

10. The experimental terminal of claim 9, wherein the charge is calculated using the equation
$${E}_{charge} = {\sum }_{i = 1}^{R} {\sum }_{j = 1}^{L} \frac{{q}_{i} {q}_{j}}{4 π ∈ {r}_{ij}}$$
whereas, R is the total number of atoms of receptor molecules contained in the molecular information, L is the total number of atoms of ligand molecules contained in the molecular information, i is a natural number representing an ith atom of the receptor molecules, j is a natural number representing a jth atom of the ligand molecules, q is a charge of atoms, and rᵢⱼ is a distance between the ith atom and the jth atom.

11. The experimental terminal of claim 9, wherein the value of Van der Waals forces is calculated using the equation
$${E}_{VWD} = {\sum }_{i = 1}^{R} {\sum }_{j = 1}^{L} ( \{ {( \frac{{v}_{i} + {v}_{j}}{{r}_{ij}} )}^{12} - {( \frac{{v}_{i} + {v}_{j}}{{r}_{ij}} )}^{6} \} \sqrt{{e}_{i} {e}_{j}} )$$
whereas, R is the total number of atoms of receptor molecules contained in the molecular information, L is the total number of atoms of ligand molecules contained in the molecular information, i is a natural number representing an ith atom of the receptor molecules, j is a natural number representing a jth atom of the ligand molecules, v is a Van der Waals radius of atoms, and rᵢⱼ is a distance between the ith atom and the jth atom.

12. The experimental terminal of claim 7, wherein the simulation unit generates experimental data of the changed molecular information, requests the collaborative server to perform a minimum energy calculation, receives a result of the minimum energy calculation of the changed molecular information from the collaborative server, and performs the docking simulation.

13. The experimental terminal of claim 12, wherein the experimental data comprises position information of the changed molecular information.

14. A method for simulating a docking of a plurality of molecules in an experimental terminal, the experimental terminal being connected to a collaborative server through a communication network and comprising a plurality of graphic processors and memories, the collaborative server supporting a collaborative experiment on a molecule, the method comprising:
receiving molecular experimental information on a molecule by being connected to the collaborative server, the molecule being targeted to be experimented;
rendering and outputting three-dimensional molecular information through a predetermined method by using the molecular experimental information;
being inputted with a command to manipulate the rendered molecular information; and
performing a docking simulation through a predetermined energy minimization calculation by changing the molecular information in accordance with the command to manipulate.

15. The method of claim 14, wherein the performing of a docking simulation through a predetermined energy minimizing calculation comprises:
serializing the molecular information;
calculating a charge and a value of Van der Waals forces of a molecule through a parallel calculation by using the serialized molecular information; and
performing a docking simulation by combining the charge and the value of Van der Waals forces.

16. The method of claim 15, wherein the calculating of a charge and a value of Van der Waals forces through a deserializing calculation by using the serialized molecular information comprises:
loading the serialized molecular information to a first graphic memory and calculating the charge by using the serialized molecular information by use of a first graphic processor, the serialized molecular information being loaded by a first thread; and
loading the serialized molecular information to a second graphic memory and calculating the value of Van der Waals forces by using the serialized molecular information by use of a second graphic processor, the serialized molecular information being loaded by a second thread,
whereas the first thread and the second thread are operated in parallel.
